(19) United States
(12) Patent Application Publication
(10) Pub. No.: US 2019/0025938 A1
(43) Pub. Date: Jan. 24, 2019

(54) SILENT INPUT MODULE AND SILENT FEEDBACK UNIT

(71) Applicant: Primax Electronics Ltd., Taipei (TW)

(72) Inventor: Chung-Yuan Chen, Taipei (TW)

(21) Appl. No.: 15/833,784

(22) Filed: Dec. 6, 2017

(30) Foreign Application Priority Data
Jul. 21, 2017 (TW) 106124612

(51) Int. Cl. G06F 3/02; G06F 3/0354; G08B 5/38

(52) U.S. Cl. CPC G06F 3/0227; H01H 13/83; G08B 5/38; G06F 3/03543

(57) ABSTRACT

A silent input module includes a silent mouse device. The silent mouse device includes a casing, a silent switch and a control unit. The control unit is disposed within the casing and in communication with the silent switch. When the silent switch is triggered, the control unit generates a control signal, and a vision unit provides a vision feedback according to the control signal. A silent feedback unit is disposed within a computing device. The computing device is in communication with a silent mouse device. The computing device includes a processing unit. After a silent switch of the silent mouse device is triggered to generate a switching signal to the processing unit, the silent feedback unit allows a vision unit to provide a vision feedback.

### FIELD OF THE INVENTION

The present invention relates to an input device, and more particularly to a silent input device and a silent feedback unit.

### BACKGROUND OF THE INVENTION

With increasing development of science and technology, multimedia products and computers become essential in our daily lives. In the computer system, the input device plays an important role for establishing the communication between the computer host and the user. The widely-used input device includes for example a mouse device, a keyboard device or a trackball device. Among these input devices, the mouse device is the most prevailing.

FIG. 1 is a schematic perspective view illustrating the appearance of a conventional mouse device. As shown in FIG. 1, the mouse device 1 comprises a casing 11, a right button 12, a left button 13 and two key switches 14 and 15. The key switches 14 and 15 are disposed within the casing 11 and aligned with the right button 12 and the left button 13, respectively. The mouse device 1 is in communication with an electronic computing device (not shown). While the casing 11 is held by the user's palm and moved, a cursor shown on a display screen is moved by an electronic computing device according to the displacement amount of the mouse device 1. When the right button 12 or the left button 13 is clicked by the user, the corresponding key switch 14 or 15 is triggered. Consequently, the electronic computing device executes a corresponding command. For example, a corresponding icon shown on the computer screen is pointed and selected, or a corresponding function is executed.

However, the design of the conventional mouse device 1 still has some drawbacks. For example, while the right button 12 or the left button 13 is clicked, an unpleasant snapping sound is generated. For solving this problem, a silent mouse device has been introduced into the market. For example, some silent mouse devices are disclosed in Taiwanese Patent Publication No. TW200701044 and Taiwanese Patent Publication No. TW201027395. However, these silent mouse devices are usually not comfortable to some users. For example, while the right button or the left button of the silent mouse device is clicked, the conventional silent mouse device cannot generate an operating feedback such as a tactile feel or a sound feedback. In other words, the conventional silent mouse device needs to be further improved.

### SUMMARY OF THE INVENTION

The present invention relates to a silent input device, and more particularly to a silent input device for providing a vision feedback to the user who operates a silent mouse device.

The present invention also relates to a silent feedback unit, and more particularly to a silent feedback unit for providing a vision feedback to the user who operates a silent mouse device.

In accordance with an aspect of the present invention, there is provided a silent input module. The silent input module includes a silent mouse device. The silent mouse device includes a casing, a silent switch and a control unit. The control unit is disposed within the casing and in communication with the silent switch. When the silent switch is triggered, the control unit generates a control signal, and a vision unit provides a vision feedback according to the control signal.

In accordance with another aspect of the present invention, there is provided a silent feedback unit. The silent feedback unit is disposed within a computing device. The computing device is in communication with a silent mouse device. The computing device includes a processing unit. After a silent switch of the silent mouse device is triggered to generate a switching signal to the processing unit, the silent feedback unit allows a vision unit to provide a vision feedback.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the appearance of a conventional mouse device;

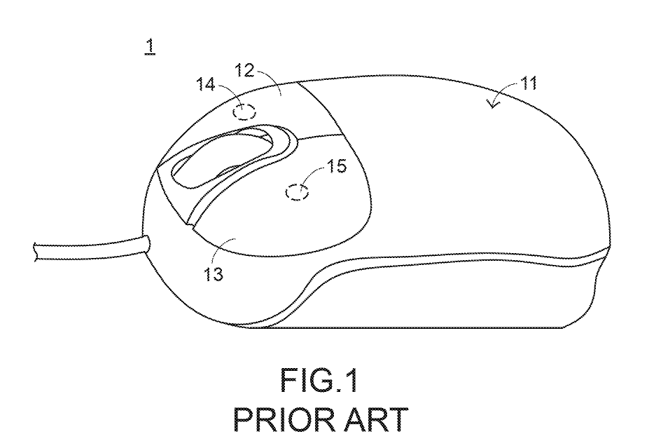

FIG. 2 schematically illustrating the operating environment of a silent input module of the present invention;

FIG. 3 is a schematic functional block diagram illustrating a silent input module according to a first embodiment of the present invention;

FIG. 4 is a schematic functional block diagram illustrating a silent input module according to a second embodiment of the present invention;

FIG. 5 is a schematic functional block diagram illustrating a silent input module according to a third embodiment of the present invention;

FIG. 6 is a schematic functional block diagram illustrating a silent input module according to a fourth embodiment of the present invention;

FIG. 7 is schematic functional block diagram illustrating a first example of the silent feedback unit that is not included in the silent input module;

FIG. 8 is schematic functional block diagram illustrating a second example of the silent feedback unit that is not included in the silent input module;

FIG. 9 is a schematic functional block diagram illustrating a silent input module according to a fifth embodiment of the present invention; and

FIG. 10 is schematic functional block diagram illustrating a third example of the silent feedback unit that is not included in the silent input module.

### DETAILED DESCRIPTION OF THE PREFERRED EMBODIMENT

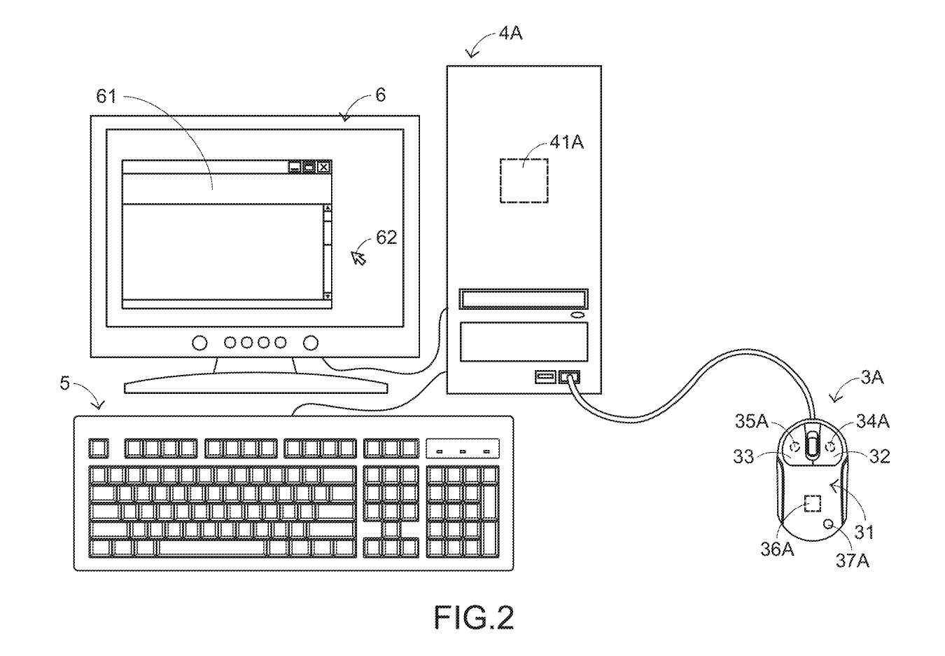

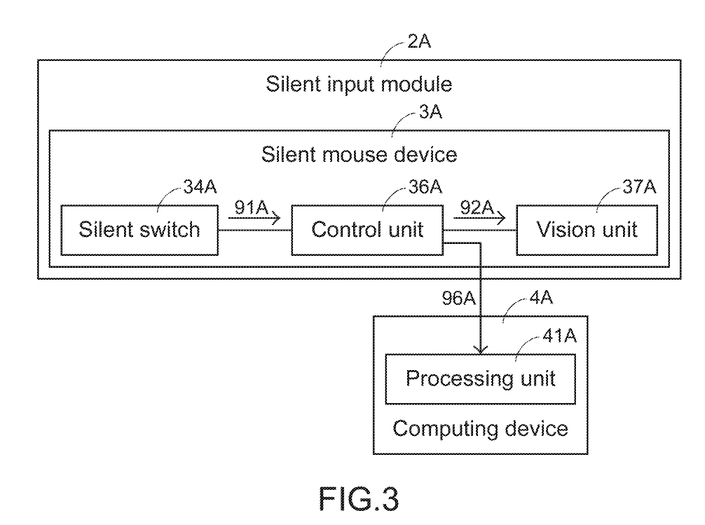

Please refer to FIGS. 2 and 3. FIG. 2 schematically illustrating the operating environment of a silent input module of the present invention. FIG. 3 is a schematic functional block diagram illustrating a silent input module according to a first embodiment of the present invention. In this embodiment, the silent input module 2A comprises a silent mouse device 3A. The silent mouse device 3A comprises a casing 31, a control unit 36A, a vision unit 37A, a right button 32, a left button 33, a silent switch 34A and a silent switch 35A. The silent switch 34A is aligned with the right button 32. The silent switch 35A is aligned with the left button 33. The right button 32 and the left button 33 are exposed outside the casing 31. The control unit 36A, the silent switch 34A and the silent switch 35A are disposed within the casing 31. The control unit 36A is in communication with the silent switch 34A, the silent switch 35A and the vision unit 37A. The silent mouse device 3A is specially designed. When the right button 32 and the left button 33 is clicked, no snapping sound or only a tiny sound is generated by the silent mouse device 3A. Consequently, the silent mouse device 3A is more user-friendly. The operations of the silent mouse device 3A to achieve the silent purpose are well known to those skilled in the art, and are not redundantly described herein.

In the operating environment of FIG. 2, the user may operate the silent input module 2A to control a computing device 4A. The computing device 4A comprises a processing unit 41A. The processing unit 41A is connected with the silent mouse device 3A and the peripheral devices. For example, the peripheral devices include a display screen 6, a luminous keyboard 5, and so on. Moreover, the processing unit 41A is in communication with the silent mouse device 3A and the peripheral devices in a wired transmission manner or a wireless transmission manner.

While the casing 31 of the silent mouse device 3A is held by the user's palm and moved, a cursor 62 shown on the display screen 6 is moved by the computing device 4A according to the displacement amount of the silent mouse device 3A. When the right button 32 or the left button 33 is clicked by the user, the corresponding silent switch 34A or 35A is triggered. Consequently, the computing device 4A executes a corresponding command. For example, a corresponding icon 61 shown on the display screen 6 is pointed and selected, or a corresponding function is executed. The implementation and principles of operating the silent mouse device 3A to control the computing device 4A are well known to those skilled in the art, and are not redundantly described herein.

In an embodiment, the vision unit 37A of the silent mouse device 3A is a light-emitting unit that emits a light beam. An example of the vision unit 37A includes but is not limited to a light emitting diode. While the right button 32 of the silent mouse device 3A is clicked, the silent switch 34A corresponding to the right button 32 is triggered to generate and output a triggering signal 91A to the control unit 36A. After the triggering signal 91A is received, the control unit 36A generates and outputs a switching signal 96A to the processing unit 41A of the computing device 4A. Consequently, the computing device 4A executes a corresponding command. In addition, the control unit 36A generates a control signal 92A to the vision unit 37A. According to the control signal 92A, the vision unit 37A generates a vision feedback corresponding to the pressing action of the right button 32 of the silent mouse device 3A. For example, the vision feedback includes a flickering effect. In this embodiment, the situation of clicking the right button 32 is taken as an example. It is noted that the above operating principle is also applied to the situation of clicking the left button 33.

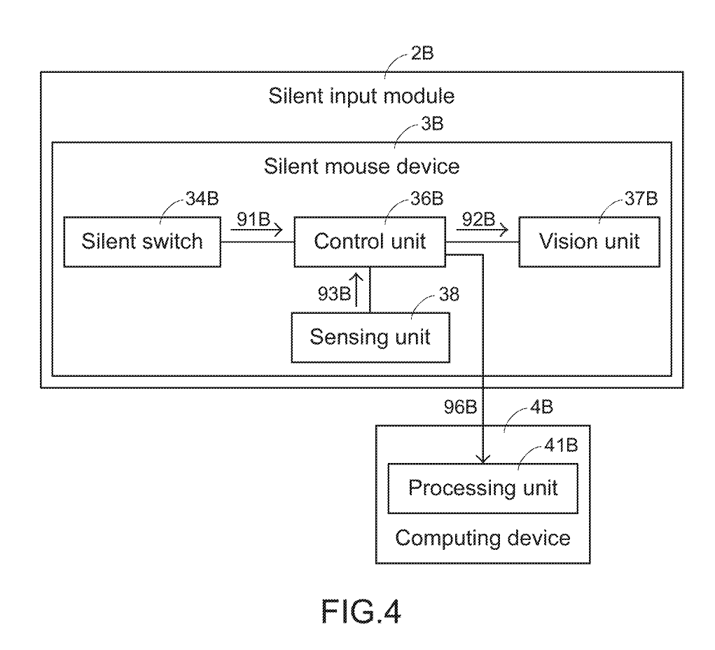

FIG. 4 is a schematic functional block diagram illustrating a silent input module according to a second embodiment of the present invention. Except for the following aspects, the components of the silent input module 2B of this embodiment are similar to those of the first embodiment, and are not redundantly described herein. In comparison with the first embodiment, the silent mouse device 3B of this embodiment further comprises a sensing unit 38. The sensing unit 38 is in communication with the control unit 36B.

While the right button (see FIG. 2) of the silent mouse device 3B is clicked, the silent switch 34B corresponding to the right button is triggered to generate and output a triggering signal 91B to the control unit 36B. By sensing the pressed level of the silent switch 34B, the sensing unit 38 generates and outputs a sensing signal 93B to the control unit 36B. According to the sensing signal 93B, the control unit 36B generates and outputs a corresponding switching signal 96B to the processing unit 41B of the computing device 4B. Consequently, the computing device 4B executes a corresponding command. Moreover, according to the sensing signal 93B, the control unit 36B generates a corresponding control signal 92B to the vision unit 37B. According to the control signal 92B, the vision unit 37B provides a corresponding vision feedback. For example, the vision feedback includes the flickering effect with a corresponding light color or a corresponding flickering frequency. In this embodiment, the situation of clicking the right button is taken as an example. It is noted that the above operating principle is also applied to the situation of clicking the left button.

In an embodiment, the sensing unit 38 is a pressure-sensing unit for sensing the pressure of pressing the silent switch 34B and generating a pressure-sensing signal to the control unit 36B. In case that the pressure-sensing signal is different, the control unit 36B generates and outputs a different switching signal 96B to the processing unit 41B of the computing device 4B. Consequently, the computing device 4B executes a different command. Since the pressure-sensing signal is different, the control unit 36B generates a different control signal 92B to the vision unit 37B. According to the control signal 92B, the vision unit 37B provides a different vision feedback.

In another embodiment, the sensing unit 38 is a displacement sensing unit for sensing the displacement of pressing the silent switch 34B and generating a displacement sensing signal to the control unit 36B. In case that the displacement sensing signal is different, the control unit 36B generates and outputs a different switching signal 96B to the processing unit 41B of the computing device 4B. Consequently, the computing device 4B executes a different command. Since the displacement sensing signal is different, the control unit 36B generates a different control signal 92B to the vision unit 37B. According to the control signal 92A, the vision unit 37B provides a different vision feedback.

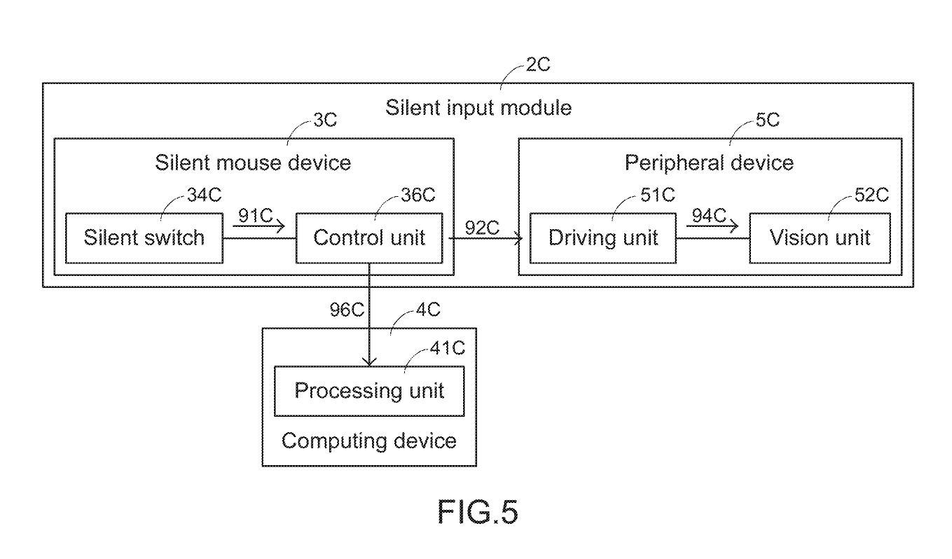

FIG. 5 is a schematic functional block diagram illustrating a silent input module according to a third embodiment of the present invention. Except for the following aspects, the components of the silent input module 2C of this embodiment are similar to those of the first and second embodiments, and are not redundantly described herein. In this embodiment, the silent mouse device 3C and a peripheral device 5C for the computing device 4C are components of the silent input module 2C. Moreover, the vision unit 52C is included in the peripheral device 5C. That is, the vision unit 52C is the component of the peripheral device 5C and is not the component of the silent mouse device 3C. The peripheral device 5C comprises the vision unit 52C and a driving unit 51C. The driving unit 51C is in communication with the control unit 36C of the silent mouse device 3C in a wired transmission manner or a wireless transmission manner.

While the right button (see FIG. 2) of the silent mouse device 3C is clicked, the silent switch 34C corresponding to the right button is triggered to generate and output a triggering signal 91C to the control unit 36C. Then, the control unit 36C generates and outputs a switching signal 96C to the processing unit 41C of the computing device 4C. Consequently, the computing device 4C executes a corresponding command. In addition, the control unit 36C generates a control signal 92C to the driving unit 51C of the peripheral device 5C. According to the control signal 92C, the driving unit 51C generates and outputs a driving signal 94C to the vision unit 52C. Consequently, the vision unit 52C generates a vision feedback corresponding to the pressing action of the right button of the silent mouse device 3C. For example, the vision feedback includes a flickering effect. In this embodiment, the situation of clicking the right button is taken as an example. It is noted that the above operating principle is also applied to the situation of clicking the left button.

In an embodiment, the peripheral device 5C is a luminous keyboard or a display screen. Preferably but not exclusively, the vision unit 52C is a light-emitting unit for providing a light beam to illuminate the luminous keyboard or the display screen, or the vision unit 52C is a screen indicator for providing a light beam.

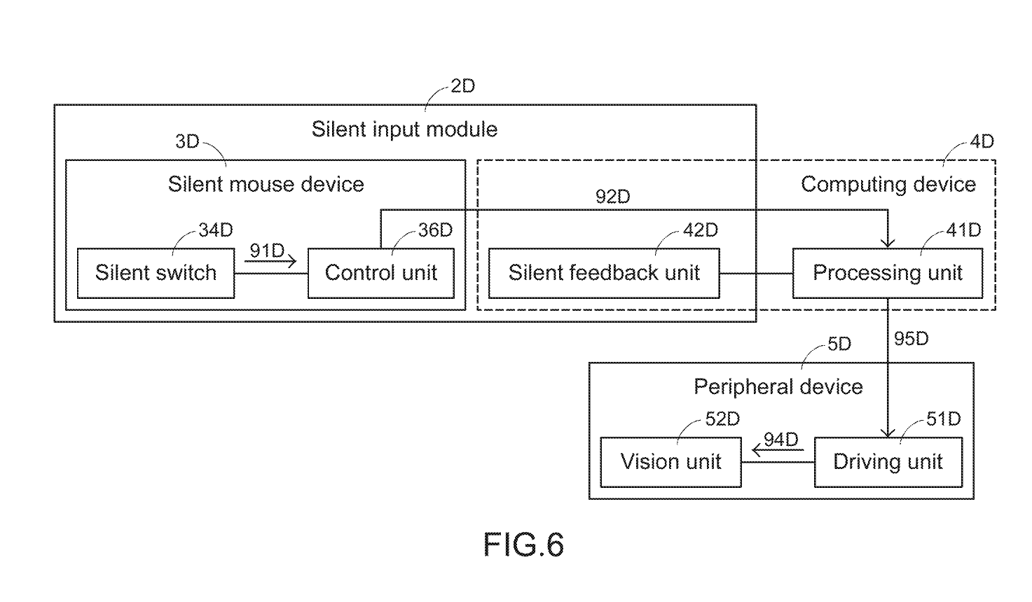

FIG. 6 is a schematic functional block diagram illustrating a silent input module according to a fourth embodiment of the present invention. Except for the following aspects, the components of the silent input module 2D of this embodiment are similar to those of the first and second embodiments, and are not redundantly described herein. In comparison with the first embodiment and the second embodiment, the silent input module 2D further comprises a silent feedback unit 42D. The silent feedback unit 42D is a software component that is installed in the computing device 4D. The vision unit 52D is included in the peripheral device 5D for the computing device 4D. That is, the vision unit 52D is the component of the peripheral device 5D and is not the component of the silent mouse device 3D. The peripheral device 5D comprises the vision unit 52D and a driving unit 51D. The driving unit 51D is in communication with the processing unit 41D of the computing device 4D in a wired transmission manner or a wireless transmission manner.

While the right button (see FIG. 2) of the silent mouse device 3D is clicked, the silent switch 34D corresponding to the right button is triggered to generate and output a triggering signal 91D to the control unit 36D. Then, the control unit 36D generates and outputs a switching signal (not shown) to the processing unit 41D of the computing device 4D. Consequently, the computing device 4D executes a corresponding command. In addition, the control unit 36D generates a control signal 92D to the processing unit 41D of the computing device 4D. After the processing unit 41D receives the control signal 92D, the silent feedback unit 42D allows the processing unit 41D to generate and output a feedback signal 95D to the driving unit 51D of the peripheral device 5D. According to the feedback signal 95D, the driving unit 51D of the peripheral device 5D generates and outputs a driving signal 94D to the vision unit 52D. Consequently, the vision unit 52D generates a vision feedback corresponding to the pressing action of the right button of the silent mouse device 3D. For example, the vision feedback includes a flickering effect. In this embodiment, the situation of clicking the right button is taken as an example. It is noted that the above operating principle is also applied to the situation of clicking the left button.

In an embodiment, the peripheral device 5D is a luminous keyboard or a display screen. Preferably but not exclusively, the vision unit 52D is a light-emitting unit for providing a light beam to illuminate the luminous keyboard or the display screen, or the vision unit 52D is a screen indicator for providing a light beam.

It is noted that the silent feedback unit is not limited to be included in the silent input module.

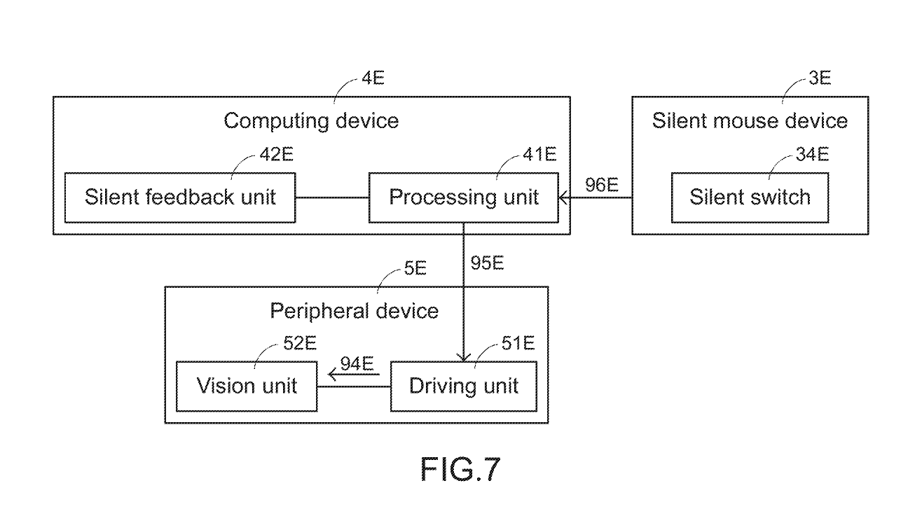

FIG. 7 is schematic functional block diagram illustrating a first example of the silent feedback unit that is not included in the silent input module. As shown in FIG. 7, the silent feedback unit 42E is an individual component that is included in the computing device 4E, and the silent feedback unit 42E is not a component of the silent input module. Moreover, the general (or conventional) silent mouse device 3E is feasible. In other words, the switching signal and the control signal outputted from the silent mouse device 3E are the same signal. For succinctness, the same signal is indicated by the switching signal 96E.

While the right button (see FIG. 2) of the silent mouse device 3E is clicked, the silent switch 34E corresponding to the right button is triggered to generate and output a switching signal 96E to the processing unit 41E of the computing device 4E. Consequently, the computing device 4E executes a corresponding command. At the same time, the silent feedback unit 42E allows the processing unit 41E to generate and output a feedback signal 95E to the driving unit 51E of the peripheral device 5E. According to the feedback signal 95E, the driving unit 51E of the peripheral device 5E generates and outputs a driving signal 94E to the vision unit 52E. Consequently, the vision unit 52E generates a vision feedback. In this embodiment, the situation of clicking the right button is taken as an example. It is noted that the above operating principle is also applied to the situation of clicking the left button.

In an embodiment, the peripheral device 5E is a luminous keyboard or a display screen. Preferably but not exclusively, the vision unit 52E is a light-emitting unit for providing a light beam to illuminate the luminous keyboard or the display screen, or the vision unit 52E is a screen indicator for providing a light beam.

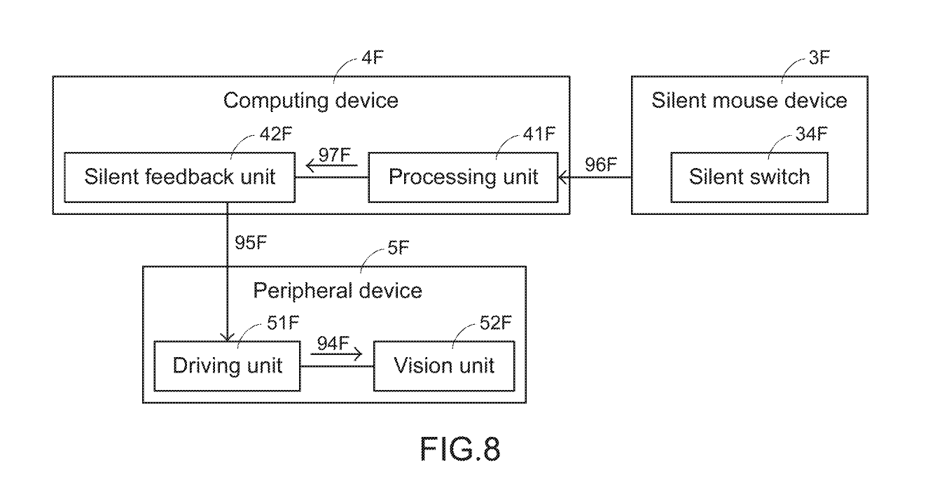

In the above embodiment, the silent feedback unit is a software component that is installed in the computing device. It is noted that the example of the silent feedback unit is not restricted. FIG. 8 is schematic functional block diagram illustrating a second example of the silent feedback unit that is not included in the silent input module. In this embodiment, the silent feedback unit 42F is a software component that is installed in the computing device 4F. For example, the silent feedback unit 42F is a USB signal port that is in communication with the processing unit 41F.

While the right button (see FIG. 2) of the silent mouse device 3F is clicked, the silent switch 34F corresponding to the right button is triggered to generate and output a switching signal 96F to the processing unit 41F of the computing device 4F. Consequently, the computing device 4F executes a corresponding command. At the same time, the processing unit 41F generates and outputs a command signal 97F to the silent feedback unit 42F. According to the command signal 97F, the processing unit 41F generates and outputs a feedback signal 95F to the driving unit 51F of the peripheral device 5F. According to the feedback signal 95F, the driving unit 51F of the peripheral device 5F generates and outputs a driving signal 94F to the vision unit 52F. Consequently, the vision unit 52F generates a vision feedback. In this embodiment, the situation of clicking the right button is taken as an example. It is noted that the above operating principle is also applied to the situation of clicking the left button.

In an embodiment, the peripheral device 5F is a luminous keyboard or a display screen. Preferably but not exclusively, the vision unit 52F is a light-emitting unit for providing a light beam to illuminate the luminous keyboard or the display screen, or the vision unit 52F is a screen indicator for providing a light beam.

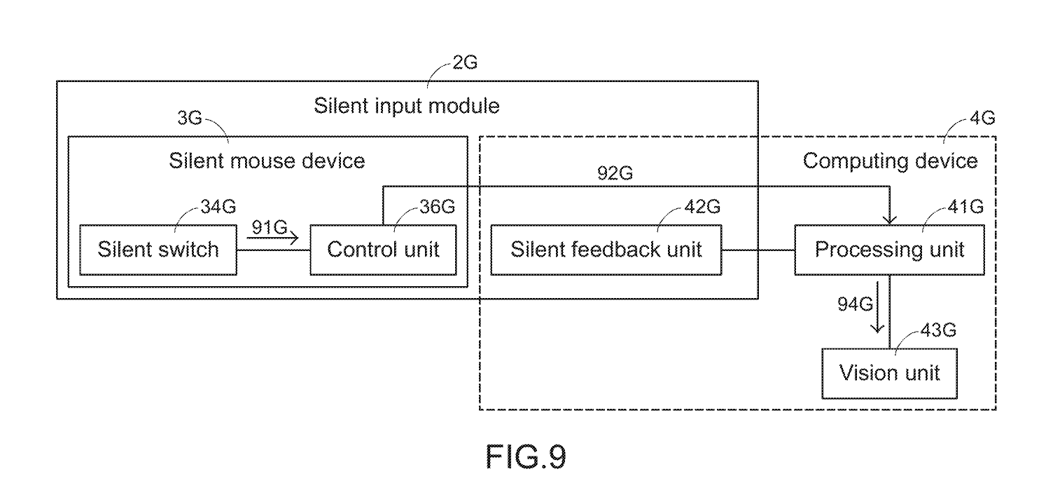

FIG. 9 is a schematic functional block diagram illustrating a silent input module according to a fifth embodiment of the present invention. Except for the following aspects, the components of the silent input module 2G of this embodiment are similar to those of the fourth embodiments, and are not redundantly described herein. In comparison with the fourth embodiment, the vision unit 43G is included in the computing device 4G and is in communication with the processing unit 41G. That is, the vision unit 43G is a component of the computing device 4G. The vision unit 43G is neither the component of the silent mouse device 3G nor the component of the periphery device.

While the right button (see FIG. 2) of the silent mouse device 3G is clicked, the silent switch 34G corresponding to the right button is triggered to generate and output a triggering signal 91G to the control unit 36G. Then, the control unit 36G generates and outputs a switching signal (not shown) to the processing unit 41G of the computing device 4G. Consequently, the computing device 4G executes a corresponding command. In addition, the control unit 36G generates a control signal 92G to the processing unit 41G of the computing device 4G. After the processing unit 41G receives the control signal 92G, the silent feedback unit 42G allows the processing unit 41G to generate and output a driving signal 94G to the vision unit 43G. Consequently, the vision unit 43G generates a vision feedback corresponding to the pressing action of the right button of the silent mouse device 3G. For example, the vision feedback includes a flickering effect. In this embodiment, the situation of clicking the right button is taken as an example. It is noted that the above operating principle is also applied to the situation of clicking the left button. Preferably but not exclusively, the vision unit 43G is a light-emitting unit for providing a light beam.

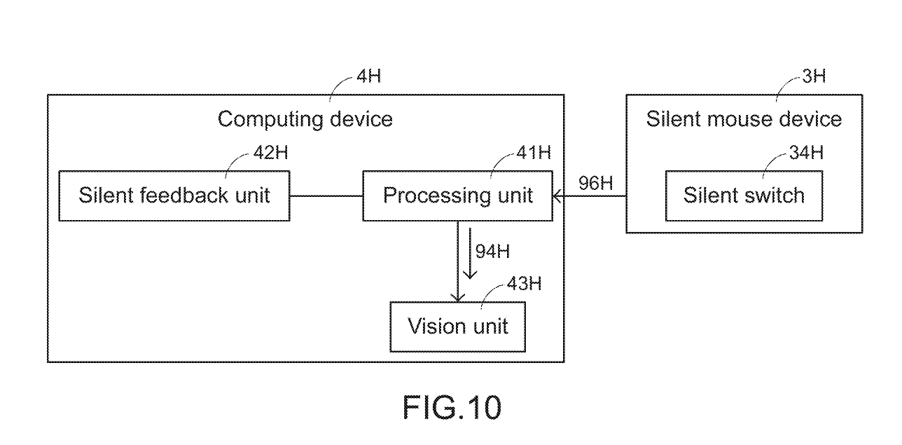

FIG. 10 is schematic functional block diagram illustrating a third example of the silent feedback unit that is not included in the silent input module. As shown in FIG. 10, the silent feedback unit 42H is an individual component included in the computing device 4H, and the silent feedback unit 42H is not a component of the silent input module. Moreover, the general (or conventional) silent mouse device 3H is feasible. In other words, the switching signal and the control signal outputted from the silent mouse device 3H are the same signal. For succinctness, the same signal is indicated by the switching signal 96H.

While the right button (see FIG. 2) of the silent mouse device 3H is clicked, the silent switch 34H corresponding to the right button is triggered to generate and output a switching signal 96H to the processing unit 41H of the computing device 4H. Consequently, the computing device 4H executes a corresponding command. At the same time, the silent feedback unit 42H allows the processing unit 41H to generate and output a driving signal 94H to the vision unit 43H. Consequently, the vision unit 43H generates a vision feedback. In this embodiment, the situation of clicking the right button is taken as an example. It is noted that the above operating principle is also applied to the situation of clicking the left button. Preferably but not exclusively, the vision unit 43H is a light-emitting unit for providing a light beam.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all modifications and similar structures.

What is claimed is:

1. A silent input module, comprising:
a silent mouse device comprising:
a casing;
a silent switch; and
a control unit disposed within the casing and in communication with the silent switch, wherein when the silent switch is triggered, the control unit generates a control signal, and a vision unit provides a vision feedback according to the control signal.

2. The silent input module according to claim 1, wherein the silent mouse device further comprises the vision unit, and the vision unit is a light-emitting unit that is disposed within the casing or disposed on the casing, wherein when the light-emitting unit is driven according to the control signal, the light-emitting unit emits a light beam.

3. The silent input module according to claim 1, wherein the vision unit is light-emitting unit that is installed on a luminous keyboard, and the luminous keyboard comprises a driving unit that is in communication with the control unit, wherein according to the control signal, the driving unit drives the light-emitting unit to emit a light beam.

4. The silent input module according to claim 3, wherein the silent input module further comprises the luminous keyboard.

5. The silent input module according to claim 1, wherein the silent input module further comprises a silent feedback unit that is included in a computing device, and the computing device is in communication with the silent mouse device, wherein after the control signal from the control unit is received by the computing device, the computing device generates a feedback signal, wherein the vision unit provides the vision feedback according to the feedback signal.

6. The silent input module according to claim 5, wherein the computing device is in communication with a peripheral device, and the peripheral device comprises a driving unit, wherein the vision unit is a light-emitting unit that is installed on the peripheral device and in communication with the driving unit, wherein the driving unit drives the light-emitting unit to emit a light beam according to the feedback signal.

7. The silent input module according to claim 6, wherein the peripheral device is a luminous keyboard or a display screen.

8. The silent input module according to claim 1, wherein the silent input module further comprises a silent feedback unit that is included in a computing device, and the computing device is in communication with the silent mouse device, wherein the computing device comprises a processing unit and the vision unit, wherein after the control signal from the control unit is received by the computing device, the processing unit drives the vision unit to provide the vision feedback.

9. The silent input module according to claim 1, wherein the silent mouse device further comprises a sensing unit, and the sensing unit is in communication with the control unit, wherein the sensing unit generates a sensing signal to the control unit according to a level of pressing the silent switch, wherein if the sensing signal is different, the control signal from the control unit is different.

10. The silent input module according to claim 9, wherein the sensing unit is a pressure-sensing unit that senses a pressure of pressing the silent switch and generates a pressure-sensing signal to the control unit according to the pressure, and the control signal from the control unit is different if the pressure-sensing signal is different; or the sensing unit is a displacement-sensing unit that senses a displacement of pressing the silent switch and generates a displacement-sensing signal to the control unit according to the displacement, and the control signal from the control unit is different if the displacement-sensing signal is different.

11. The silent input module according to claim 9, wherein if the control signal from the control unit is different, the vision feedback provided by the vision unit is different.

12. The silent input module according to claim 11, wherein if the control signal from the control unit is different, the vision unit emits a light beam with a different light color or the vision unit provides a flickering effect with a different flickering frequency.

13. A silent feedback unit disposed within a computing device, the computing device being in communication with a silent mouse device, the computing device comprising a processing unit, wherein after a silent switch of the silent mouse device is triggered to generate a switching signal to the processing unit, the silent feedback unit allows a vision unit to provide a vision feedback.

14. The silent feedback unit according to claim 13, wherein the vision unit is light-emitting unit that is installed on the computing device, wherein after the switching signal is received by the processing signal, the silent feedback unit allows the processing unit to drive the light-emitting unit to emit a light beam.

15. The silent feedback unit according to claim 13, wherein the computing device is in communication with a peripheral device, and the peripheral device comprises a driving unit, wherein the vision unit is a light-emitting unit that is installed on the peripheral device and in communication with the driving unit, wherein after the switching signal is received by the processing signal, the silent feedback unit allows the processing unit to generate a feedback signal to the driving unit, and the driving unit drives the light-emitting unit to emit a light beam according to the feedback signal.

16. The silent feedback unit according to claim 15, wherein the peripheral device is a luminous key or a display screen.

17. The silent feedback unit according to claim 13, wherein the computing device is in communication with a peripheral device, and the peripheral device comprises a driving unit, wherein the vision unit is a light-emitting unit that is installed on the peripheral device and in communication with the driving unit, wherein after the switching signal is received by the processing signal, the silent feedback unit generates a feedback signal to the driving unit, and the driving unit drives the light-emitting unit to emit a light beam according to the feedback signal.

18. The silent feedback unit according to claim 17, wherein the peripheral device is a luminous key or a display screen.
